(19) United States
(12) Patent Application Publication
(10) Pub. No.: US 2015/0169059 A1
(43) Pub. Date: Jun. 18, 2015

(54) DISPLAY APPARATUS WITH HAPTIC FEEDBACK

(71) Applicant: Nokia Corporation, Espoo (FI)

(72) Inventors: Thorsten Behles, Kangasala (FI); Marko Tapani Yliaho, Tampere (FI); Jouko Sormunen, Espoo (FI)

(21) Appl. No.: 14/389,980

(22) PCT Filed: Apr. 18, 2012
(86) PCT No.: PCT/IB2012/051945

§ 371 Date: Feb. 9, 2015

(51) Int. Cl. G06F 3/01; G06F 3/0488; G06F 3/041

(52) U.S. Cl. CPC G06F 3/016; G06F 3/0416; G06F 3/0488

(57) ABSTRACT

An apparatus comprising: a touch controller configured to determine at least one touch input parameter for at least one user interface element of a display; the touch controller further configured to determine a touch event dependent on the parameter; and a tactile effect generator configured to generate a tactile feedback signal to be output by the display dependent on the touch event such that the at least one user interface element provides a simulated experience.

### FIELD

The present invention relates to a providing tactile functionality. The invention further relates to, but is not limited to, display apparatus providing tactile functionality for use in mobile devices.

### BACKGROUND

Many portable devices, for example mobile telephones, are equipped with a display such as a glass or plastic display window for providing information to the user. Furthermore such display windows are now commonly used as touch sensitive inputs. The use of a touch sensitive input with the display has the advantage over a mechanical keypad in that the display may be configured to show a range of different inputs depending on the operating mode of the device. For example, in a first mode of operation the display may be enabled to enter a phone number by displaying a simple numeric keypad arrangement and in a second mode the display may be enabled for text input by displaying an alphanumeric display configuration such as a simulated Qwerty keyboard display arrangement.

However touching a “button” on a virtual keyboard is more difficult than a real button. The user sometimes has to visually check whether the device or apparatus has accepted the specific input. In some cases the apparatus can provide a visual feedback and an audible feedback. In some further devices the audible feedback is augmented with a vibrating motor used to provide a haptic feedback so the user knows that the device has accepted the input.

Pure audio feedback has the disadvantage that pure audio feedback has a disadvantage that it is audible by people around you and therefore able to distract or cause a nuisance especially on public transport. Furthermore pure audio feedback has the disadvantage that it can emulate reality only partially by providing the audible portion of the feedback but not a tactile portion of the feedback.

Using a vibra to implement haptic feedback can introduce a significant latency between the user input and visual feedback and vibra feedback. Furthermore vibra components can have the disadvantage that they are relatively slow even compared to audible feedback. There is usually a ramp up time of a few milliseconds from start up to vibration within the vibra. The vibra also typically cannot be stopped very quickly such that in some cases the apparatus is required to send a special breaking pulse into the vibrating motor to stop it. The difference between a vibra feedback imitation of a button click and a real mechanical button click is still therefore very large. Vibras also typically have a disadvantage that vibra component performance differs considerably between manufacturers even though both meet a design specification and therefore make designing an effective and consistent vibra system difficult.

### STATEMENT

According to an aspect, there is provided a method comprising: determining at least one touch input parameter for at least one user interface element of a display; determining a touch event dependent on the parameter; and generating a tactile feedback signal to be output by the display dependent on the touch event such that the at least one user interface element provides a simulated experience.

Determining at least one touch input parameter may comprise at least one of: determining a touch location; determining a touch position; determining a touch pressure; determining a touch force; determining a touch period; determining a touch duration; and determining a touch motion.

Determining a touch force may comprise at least one of: determining a force sensor output; and determining a touch contact area size, wherein the touch force is proportional to the touch contact area size.

The user interface element of a display may comprise a switch and determining a touch event may comprise at least one of: determining at least one switch actuation point; determining a switch end stop point; determining a switch actuation period; and determining at least one switch actuation release point.

The user interface element of a display may comprise a slider and determining a touch event may comprise at least one of: determining at least one slider end stop; determining at least one slider sector transition position; determining at least one slider determined position; and determining at least one slider actuation point.

The at least one slider determined position may comprise at least one of: a fixed position; a position dependent on a sensor input; and a position dependent on a user input.

The user interface element of a display may comprise a dial and determining a touch event may comprise at least one of: determining at least one dial end stop; determining at least one dial sector transition position; determining at least one dial determined position; and determining at least one dial actuation point.

The user interface element of a display may comprise a drag and drop input and determining a touch event may comprise at least one of: determining a selection input; determining a drop input; determining a boundary transition position; and determining a collision position.

The user interface element of a display may comprise a scrolling input and determining a touch event may comprise at least one of: determining a motion input; and determining a boundary event for a display component.

The user interface element of a display may comprise a press and release input and determining a touch event comprises at least one of: determining an activation input; and determining a release input.

The user interface element of a display may comprise a latched switch input and determining a touch event comprises at least one of: determining a first activation input; determining a latched release input; determining a latched activation input; and determining a release input.

The user interface element of a display may comprise a rollerball and determining a touch event may comprise at least one of: determining a motion input in a first direction; determining a motion input in a second direction; determining an activation input; and determining a release input.

The user interface element may comprise an isometric joystick and determining a touch event comprises at least one of: determining a distance input in a first direction; determining a distance input in a second direction; determining an activation input; and determining a release input.

The method may further comprise generating an audio feedback signal to be output by the display dependent on the touch event.

The method may further comprise outputting on the display the tactile feedback signal.

Generating a tactile feedback signal may comprise: determining a first feedback signal; modifying the first feedback signal dependent on the touch event; and outputting the modified first feedback signal to an actuator to produce the tactile feedback signal.

According to a second aspect there is provided apparatus comprising at least one processor and at least one memory including computer code for one or more programs, the at least one memory and the computer code configured to with the at least one processor cause the apparatus to at least perform: determining at least one touch input parameter for at least one user interface element of a display; determining a touch event dependent on the parameter; and generating a tactile feedback signal to be output by the display dependent on the touch event such that the at least one user interface element provides a simulated experience.

Determining at least one touch input parameter may cause the apparatus to perform at least one of: determining a touch location; determining a touch position; determining a touch pressure; determining a touch force; determining a touch period; determining a touch duration; and determining a touch motion.

Determining a touch force may cause the apparatus to perform at least one of: determining a force sensor output; and determining a touch contact area size, wherein the touch force is proportional to the touch contact area size.

The user interface element of a display may comprise a switch and determining a touch event may cause the apparatus to perform at least one of: determining at least one switch actuation point; determining a switch end stop point; determining a switch actuation period; and determining at least one switch actuation release point.

The user interface element of a display may comprise a slider and determining a touch event may cause the apparatus to perform at least one of: determining at least one slider end stop; determining at least one slider sector transition position; determining at least one slider determined position; and determining at least one slider actuation point.

The at least one slider determined position may comprise at least one of: a fixed position; a position dependent on a sensor input; and a position dependent on a user input.

The user interface element of a display may comprise a dial and determining a touch event may cause the apparatus to perform at least one of: determining at least one dial end stop; determining at least one dial sector transition position; determining at least one dial determined position; and determining at least one dial actuation point.

The user interface element of a display may comprise a drag and drop input and determining a touch event may cause the apparatus to perform at least one of: determining a selection input; determining a drop input; determining a boundary transition position; and determining a collision position.

The user interface element of a display may comprise a scrolling input and determining a touch event may cause the apparatus to perform at least one of: determining a motion input; and determining a boundary event for a display component.

The user interface element of a display may comprise a press and release input and determining a touch event may cause the apparatus to perform at least one of: determining an activation input; and determining a release input.

The user interface element of a display may comprise a latched switch input and determining a touch event may cause the apparatus to perform at least one of: determining a first activation input; determining a latched release input; determining a latched activation input; and determining a release input.

The user interface element of a display may comprise a rollerball and determining a touch event may cause the apparatus to perform at least one of: determining a motion input in a first direction; determining a motion input in a second direction; determining an activation input; and determining a release input.

The user interface element may comprise an isometric joystick and determining a touch event may cause the apparatus to perform at least one of: determining a distance input in a first direction; determining a distance input in a second direction; determining an activation input; and determining a release input.

The apparatus may be further configured to generate an audio feedback signal to be output by the display dependent on the touch event.

The apparatus may be further configured to output on the display the tactile feedback signal.

Generating a tactile feedback signal may cause the apparatus to perform: determining a first feedback signal; modifying the first feedback signal dependent on the touch event; and outputting the modified first feedback signal to an actuator to produce the tactile feedback signal.

According to third aspect there is provided an apparatus comprising: means for determining at least one touch input parameter for at least one user interface element of a display; means for determining a touch event dependent on the parameter; and means for generating a tactile feedback signal to be output by the display dependent on the touch event such that the at least one user interface element provides a simulated experience.

The means for determining at least one touch input parameter may comprise at least one of: means for determining a touch location; means for determining a touch position; means for determining a touch pressure; means for determining a touch force; means for determining a touch period; means for determining a touch duration; and means for determining a touch motion.

The means for determining a touch force comprises at least one of: means for determining a force sensor output; and means for determining a touch contact area size, wherein the touch force is proportional to the touch contact area size.

The user interface element of a display may comprise a switch and the means for determining a touch event may comprise at least one of: means for determining at least one switch actuation point; means for determining a switch end stop point; means for determining a switch actuation period; and means for determining at least one switch actuation release point.

The user interface element of a display may comprise a slider and the means for determining a touch event may comprise at least one of: means for determining at least one slider end stop; means for determining at least one slider sector transition position; means for determining at least one slider determined position; means for and determining at least one slider actuation point.

The at least one slider determined position may comprise at least one of: a fixed position; a position dependent on a sensor input; and a position dependent on a user input.

The user interface element of a display may comprise a dial and the means for determining a touch event may comprises at least one of: means for determining at least one dial end stop; means for determining at least one dial sector transition position; means for determining at least one dial determined position; and means for determining at least one dial actuation point.

The user interface element of a display may comprise a drag and drop input and the means for determining a touch event may comprise at least one of: means for determining a selection input; means for determining a drop input; means for determining a boundary transition position; and means for determining a collision position.

The user interface element of a display may comprise a scrolling input and the means for determining a touch event may comprise at least one of: means for determining a motion input; and means for determining a boundary event for a display component.

The user interface element of a display may comprise a press and release input and the means for determining a touch event may comprise at least one of: means for determining an activation input; and means for determining a release input.

The user interface element of a display may comprise a latched switch input and means for determining a touch event may comprise at least one of: means for determining a first activation input; means for determining a latched release input; means for determining a latched activation input; and means for determining a release input.

The user interface element of a display may comprise a rollerball and the means for determining a touch event may comprise at least one of: means for determining a motion input in a first direction; means for determining a motion input in a second direction; means for determining an activation input; and means for determining a release input.

The user interface element may comprise an isometric joystick and the means for determining a touch event may comprise at least one of: means for determining a distance input in a first direction; means for determining a distance input in a second direction; means for determining an activation input; and means for determining a release input.

The apparatus may further comprise means for generating an audio feedback signal to be output by the display dependent on the touch event.

The apparatus may further comprise means for outputting on the display the tactile feedback signal.

The means for generating a tactile feedback signal may comprise: means for determining a first feedback signal; means for modifying the first feedback signal dependent on the touch event; and means for outputting the modified first feedback signal to an actuator to produce the tactile feedback signal.

According to a fourth aspect there is provided an apparatus comprising: a touch controller configured to determine at least one touch input parameter for at least one user interface element of a display; the touch controller further configured to determine a touch event dependent on the parameter; and a tactile effect generator configured to generate a tactile feedback signal to be output by the display dependent on the touch event such that the at least one user interface element provides a simulated experience.

The touch controller may be configured to determine at least one of: a touch location; a touch position; a touch pressure; a touch force; a touch period; a touch duration; and a touch motion.

The touch controller when determining a touch force may comprise at least one of: an input configured to receive a force sensor output; and a contact area determiner configured to determine a touch contact area size, wherein the touch force is proportional to the touch contact area size.

The user interface element of a display may comprise a switch and the touch controller may be configured to determine at least one of: at least one switch actuation point; a switch end stop point; a switch actuation period; and at least one switch actuation release point.

The user interface element of a display may comprise a slider and the touch controller may be configured to determine at least one of: at least one slider end stop; at least one slider sector transition position; at least one slider determined position; and at least one slider actuation point.

The at least one slider determined position may comprise at least one of: a fixed position; a position dependent on a sensor input; and a position dependent on a user input.

The user interface element of a display may comprise a dial and the touch controller may be configured to determine at least one of: at least one dial end stop; at least one dial sector transition position; at least one dial determined position; and at least one dial actuation point.

The user interface element of a display may comprise a drag and drop input and the touch controller may be configured to determine at least one of: a selection input; a drop input; a boundary transition position; and a collision position.

The user interface element of a display may comprise a scrolling input and the touch controller may be configured to determine at least one of: determine: a motion input; and a boundary event for a display component.

The user interface element of a display may comprise a press and release input and the touch controller may be configured to determine at least one of: an activation input; and a release input.

The user interface element of a display may comprise a latched switch input and the touch controller may be configured to determine at least one of: a first activation input; a latched release input; a latched activation input; and a release input.

The user interface element of a display may comprise a rollerball and the touch controller may be configured to determine at least one of: a motion input in a first direction; a motion input in a second direction; an activation input; and a release input.

The user interface element may comprise an isometric joystick and the touch controller may be configured to determine at least one of: a distance input in a first direction; a distance input in a second direction; an activation input; and a release input.

The tactile effect generator may be configured to generate an audio feedback signal to be output by the display dependent on the touch event.

The apparatus may further comprise a display, wherein the display is configured to output the tactile feedback signal.

The tactile effect generator may comprise: a first feedback signal determiner configured to determine a first feedback signal; a feedback signal modifier configured to modify the first feedback signal dependent on the touch event; and an output configured to output the modified first feedback signal to an actuator to produce the tactile feedback signal.

A computer program product stored on a medium for causing an apparatus to may perform the method as described herein.

An electronic device may comprise apparatus as described herein.

A chipset may comprise apparatus as described herein.

### SUMMARY OF FIGURES

For better understanding of the present invention, reference will now be made by way of example to the accompanying drawings in which:

FIG. 1 shows schematically an apparatus suitable for employing some embodiments;

FIG. 2 shows schematically an example tactile audio display with transducer suitable for implementing some embodiments;

FIG. 3 shows a typical mechanical button;

FIG. 4 shows schematically a graph showing the operation force against stroke (displacement) profile for a typical mechanical button;

FIG. 5 shows an example display keyboard suitable for the tactile audio display according to some embodiments;

FIG. 6 shows schematically tactile effect generation system apparatus with 2 piezo actuators according to some embodiments;

FIG. 7 shows a tactile effect generator system apparatus with separate amplifier channels according to some embodiments;

FIG. 8 shows schematically a tactile effect generator system apparatus incorporating a force sensor according to some embodiments;

FIG. 9 shows schematically a tactile effect generator system apparatus incorporating an audio output according to some embodiments;

FIG. 10 shows a flow diagram of the operation of the touch effect generation system apparatus with respect to a simulated mechanical button effect according to some embodiments;

FIG. 11 shows a flow diagram of the operation of the simulated mechanical button effect using touch diameter as an input according to some embodiments;

FIG. 12 shows a flow diagram of the operation of the simulated mechanical button effect using a force or pressure sensor as an input according to some embodiments;

FIG. 13 shows suitable haptic feedback signals according to some embodiments;

FIG. 14 shows an example slider display suitable for the tactile audio display according to some embodiments;

FIG. 15 shows in further detail slider components with respect to the tactile audio display according to some embodiments;

FIG. 16 shows a flow diagram of the operation of the tactile effect generator system apparatus with respect to a simulated slider effect according to some embodiments;

FIG. 17 shows an example knob or dial display suitable for the tactile audio display according to some embodiments;

FIG. 18 shows in further detail knob or dial components according to some embodiments; and

FIG. 19 shows a flow diagram of the operation of the tactile effect generator system apparatus with respect to a simulated knob or dial effect according to some embodiments.

### DESCRIPTION OF EXAMPLE EMBODIMENTS

The application describes apparatus and methods capable of generating, encoding, storing, transmitting and outputting tactile and acoustic outputs from a touch screen device.

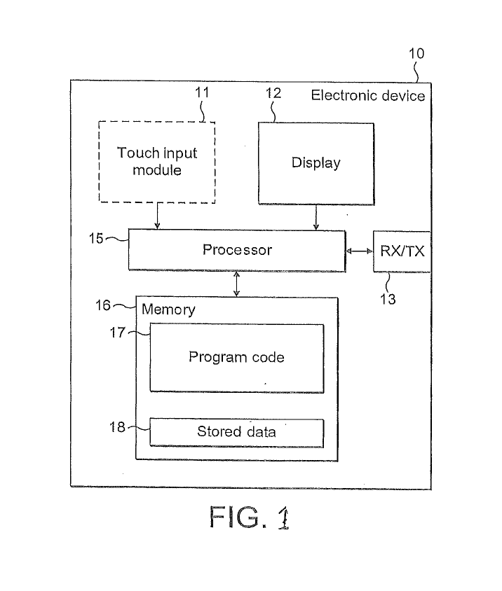

With respect to FIG. 1 a schematic block diagram of an example electronic device 10 or apparatus on which embodiments of the application can be implemented. The apparatus 10 is such embodiments configured to provide improved tactile and acoustic wave generation.

The apparatus 10 is in some embodiments a mobile terminal, mobile phone or user equipment for operation in a wireless communication system. In other embodiments, the apparatus is any suitable electronic device configured to provide an image display, such as for example a digital camera, a portable audio player (mp3 player), a portable video player (mp4 player). In other embodiments the apparatus can be any suitable electronic device with touch interface (which may or may not display information) such as a touch-screen or touch-pad configured to provide feedback when the touch-screen or touch-pad is touched. For example in some embodiments the touch-pad can be a touch-sensitive keypad which can in some embodiments have no markings on it and in other embodiments have physical markings or designations on the front window. An example of such a touch sensor can be a touch sensitive user interface to replace keypads in automatic teller machines (ATM) that does not require a screen mounted underneath the front window projecting a display. The user can in such embodiments be notified of where to touch by a physical identifier—such as a raised profile, or a printed layer which can be illuminated by a light guide.

The apparatus 10 comprises a touch input module or user interface 11, which is linked to a processor 15. The processor 15 is further linked to a display 12. The processor 15 is further linked to a transceiver (TX/RX) 13 and to a memory 16.

In some embodiments, the touch input module 11 and/or the display 12 are separate or separable from the electronic device and the processor receives signals from the touch input module 11 and/or transmits and signals to the display 12 via the transceiver 13 or another suitable interface. Furthermore in some embodiments the touch input module 11 and display 12 are parts of the same component. In such embodiments the touch interface module 11 and display 12 can be referred to as the display part or touch display part.

The processor 15 can in some embodiments be configured to execute various program codes. The implemented program codes, in some embodiments can comprise such routines as touch processing, input simulation, or tactile effect simulation code where the touch input module inputs are detected and processed, effect feedback signal generation where electrical signals are generated which when passed to a transducer can generate tactile or haptic feedback to the user of the apparatus, or actuator processing configured to generate an actuator signal for driving an actuator. The implemented program codes can in some embodiments be stored for example in the memory 16 and specifically within a program code section 17 of the memory 16 for retrieval by the processor 15 whenever needed. The memory 15 in some embodiments can further provide a section 18 for storing data, for example data that has been processed in accordance with the application, for example pseudo-audio signal data.

The touch input module 11 can in some embodiments implement any suitable touch screen interface technology. For example in some embodiments the touch screen interface can comprise a capacitive sensor configured to be sensitive to the presence of a finger above or on the touch screen interface. The capacitive sensor can comprise an insulator (for example glass or plastic), coated with a transparent conductor (for example indium tin oxide—ITO). As the human body is also a conductor, touching the surface of the screen results in a distortion of the local electrostatic field, measurable as a change in capacitance. Any suitable technology may be used to determine the location of the touch. The location can be passed to the processor which may calculate how the user's touch relates to the device. The insulator protects the conductive layer from dirt, dust or residue from the finger.

In some other embodiments the touch input module can be a resistive sensor comprising of several layers of which two are thin, metallic, electrically conductive layers separated by a narrow gap. When an object, such as a finger, presses down on a point on the panel's outer surface the two metallic layers become connected at that point: the panel then behaves as a pair of voltage dividers with connected outputs. This physical change therefore causes a change in the electrical current which is registered as a touch event and sent to the processor for processing.

In some other embodiments the touch input module can further determine a touch using technologies such as visual detection for example a camera either located below the surface or over the surface detecting the position of the finger or touching object, projected capacitance detection, infra-red detection, surface acoustic wave detection, dispersive signal technology, and acoustic pulse recognition. In some embodiments it would be understood that ‘touch’ can be defined by both physical contact and ‘hover touch’ where there is no physical contact with the sensor but the object located in close proximity with the sensor has an effect on the sensor.

The apparatus 10 can in some embodiments be capable of implementing the processing techniques at least partially in hardware, in other words the processing carried out by the processor 15 may be implemented at least partially in hardware without the need of software or firmware to operate the hardware.

The transceiver 13 in some embodiments enables communication with other electronic devices, for example in some embodiments via a wireless communication network.

The display 12 may comprise any suitable display technology. For example the display element can be located below the touch input module and project an image through the touch input module to be viewed by the user. The display 12 can employ any suitable display technology such as liquid crystal display (LCD), light emitting diodes (LED), organic light emitting diodes (OLED), plasma display cells, Field emission display (FED), surface-conduction electron-emitter displays (SED), and Electophoretic displays (also known as electronic paper, e-paper or electronic ink displays). In some embodiments the display 12 employs one of the display technologies projected using a light guide to the display window. As described herein the display 12 in some embodiments can be implemented as a physical fixed display. For example the display can be a physical decal or transfer on the front window. In some other embodiments the display can be located on a physically different level from the rest of the surface, such a raised or recessed marking on the front window. In some other embodiments the display can be a printed layer illuminated by a light guide under the front window

The concept of the embodiments described herein is to implement simulated experiences using the display and tactile outputs and in some embodiments display, tactile and audio outputs. In some embodiments the simulated experiences are simulations of mechanical buttons, sliders, and knobs and dials effectively using tactile effects. Furthermore these tactile effects can be employed for any suitable haptic feedback wherein an effect is associated with a suitable display input characteristic. For example the pressure points on a simulated mechanical button, mechanical slider or rotational knob or dial.

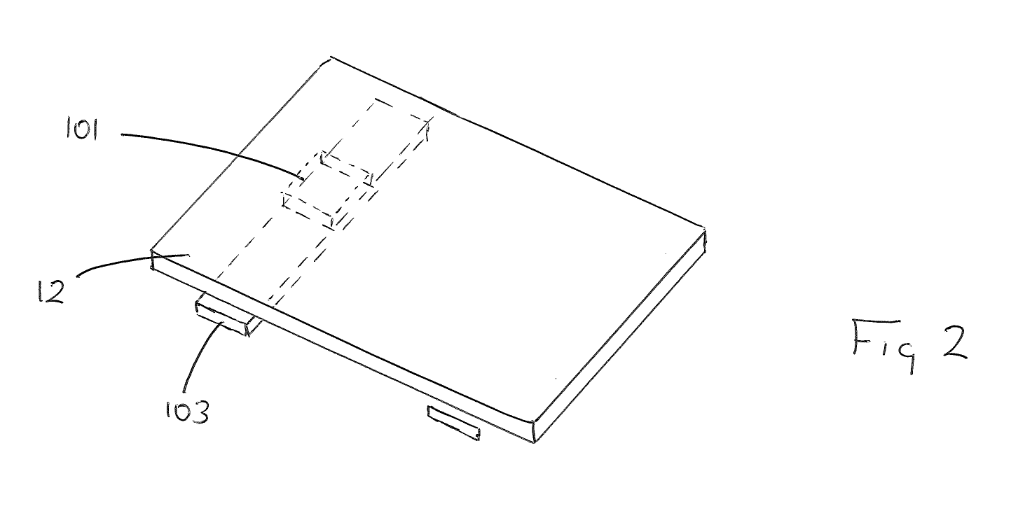

An example tactile audio display component comprising the display and tactile feedback generator is shown in FIG. 2. FIG. 2 specifically shows the touch input module 11 and display 12 under which is coupled a pad 101 which can be driven by the transducer 103 located underneath the pad. The motion of the transducer 103 can then be passed through the pad 101 to the display 12 which can then be felt by the user. The transducer or actuator 103 can in some embodiments be a piezo or piezo electric transducer configured to generate a force, such as a bending force when a current is passed through the transducer. This bending force is thus transferred via the pad 101 to the display 12.

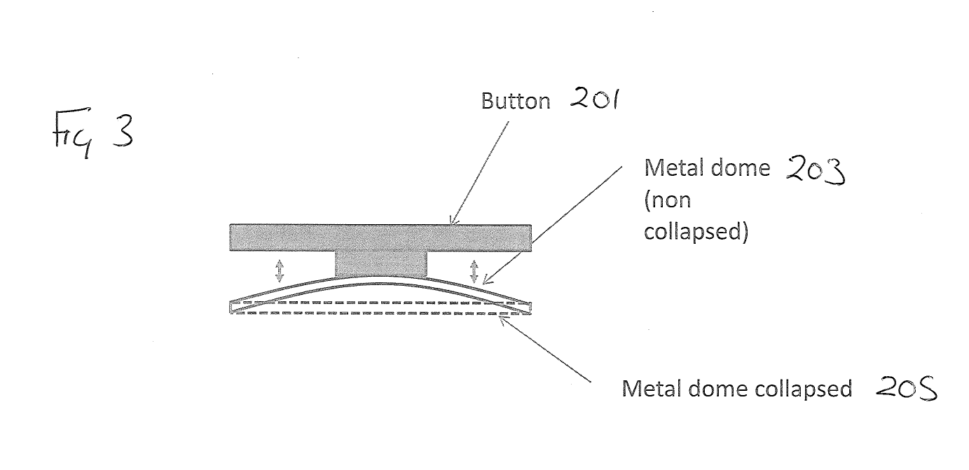

To explain how the tactile audio display can simulate a mechanical button press an example mechanical button is shown in FIG. 3. The mechanical button implementation comprises a button 201 located over a resilient member. The resilient member in the example shown in FIG. 3 is a metal dome spring. The metal dome spring can in a first and resting position and active or operational position and intermediate positions between these two end or stop positions. In other words when no force is applied to the button 201 the button can rest in a dome position 203 and when a user presses on the button with sufficient force or pressure the force causes the metal dome to collapse shown by the dashed line 205.

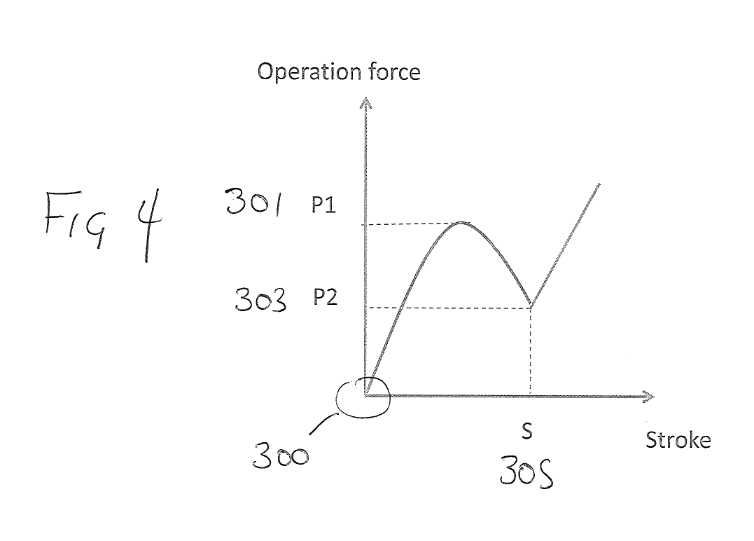

With respect to FIG. 4 an example mechanical button operation force/stroke profile is shown. The graph or profile describes the tactile definition of the mechanical dome. The mechanical dome performance is indicated not only by the size and height but also the click ratio (also known as tactility), the operational force P1, the operational stroke, and the contact force P2.

The click ratio as a percentage is typically defined as:

Click ratio=((P1−P2)/P1)×100.

This is shown in FIG. 4 where P1 represents the operation force for the button, in other words the force required to start the dome to collapse, P2 defines the contact force in other words the force required after the operation force to enable the button to contact the mechanical switch element, and S represents the switching stroke.

A typical operational force of a mechanical button is in the order of 1.6 N. Although a typical click ratio for a mechanical button is in the range of 40% a higher the click ratio produces a more satisfying the button press, a button click ratio greater than 50% has a possibility of a non-reverse condition.

Furthermore ergonomically a low P2 value is considered to be better.

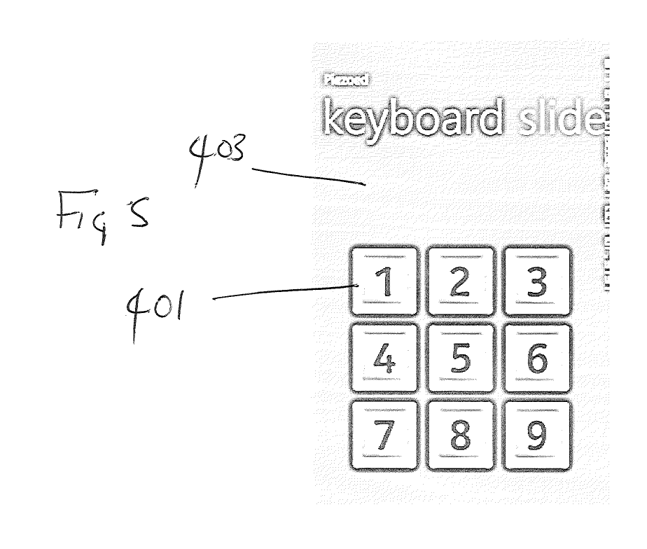

With respect to FIG. 5 an example keyboard button image is shown where the background 403 has located on it 9 buttons, of which only the first button 401 is labelled and indicated. It would be understood that in some embodiments there may be more than or fewer than nine buttons on the display and in the following examples a single simulation button is shown. In some implementation the concept of the embodiments described herein is to provide the tactile audio display with apparatus where the user interface interactions such as buttons generate a haptic effect more closely simulating the mechanical counterparts. In some embodiments these effects can be preloaded to memory in order to minimise latency. Furthermore when the button reports a touch event (such as a touch press or touch release) an associated sound can be played quickly resulting in the display vibrating which is then sensed by the fingertip and also in some cases heard.

The concept of mechanical button simulation feedback with the tactile audio display is thus to have the tactile audio display to perform a series of 5 steps:

Step 1: the finger touches the display but does not apply force

Step 2: the finger presses the button with some force

Step 3: the finger presses the display with the “maximum dome force” and the tactile audio display simulates the dome collapse

Step 4: the tactile audio display simulates the dome reaching the bottom of motion (in other words the tactile audio display simulates the dome becoming flat)

Step 5: the finger force increases however the motion or dome does not move any further.

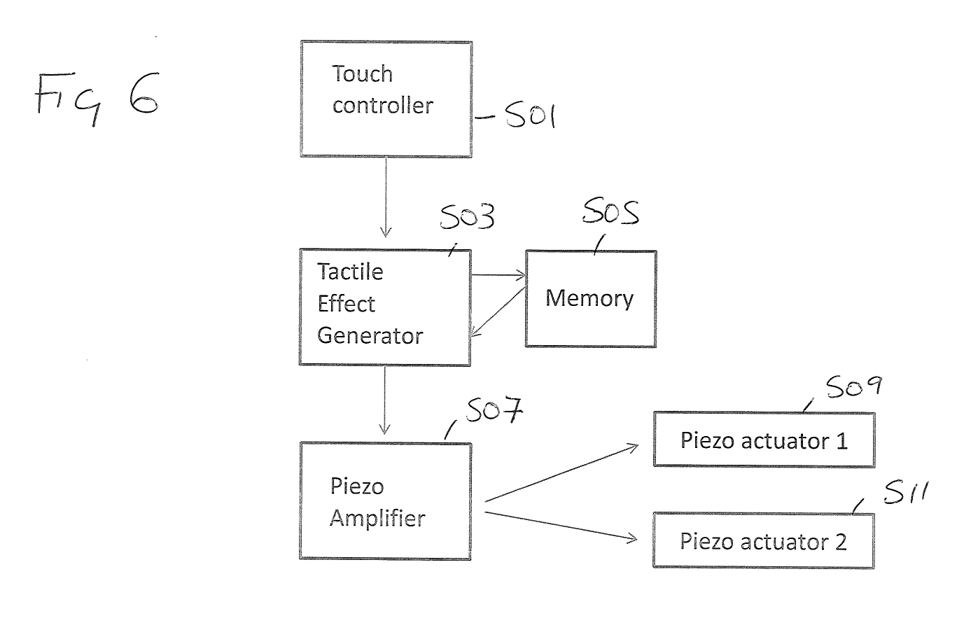

With respect to FIGS. 6 to 9 suitable tactile effects generator system apparatus are described with respect to embodiments of the application.

With respect to FIG. 6 a first tactile effect generator system apparatus is described. In some embodiments the apparatus comprise a touch controller 501. The touch controller 501 can be configured to receive input from the tactile audio display or touch screen. The touch controller 501 can then be configured to process these inputs to generate suitable digital representations or characteristics associated with the touch such as: number of touch inputs; location of touch inputs; size of touch inputs; shape of touch input; position relative to other touch inputs; etc. The touch controller 501 can output the touch input parameters to a tactile effect generator 503.

In some embodiments the apparatus comprises a tactile effect generator 503, application process engine or suitable tactile effect mean. The tactile effect generator 503 is configured to receive the touch parameters from the touch controller 501 and process the touch parameters to determine whether or not a tactile effect is to be generated, which tactile effect is to be generated, and where the tactile effect is to be generated.

In some embodiments the tactile effect generator 503 can be configured to receive and request information or data from the memory 505. For example in some embodiments the tactile effect generator can be configured to retrieve specific tactile effect signals from the memory in the form of a look up table dependent on the state of the tactile effect generator 503.

In some embodiments the apparatus comprises a memory 505. The memory 505 can be configured to communicate with the tactile effect generator 503. In some embodiments the memory 505 can be configured to store suitable tactile effect “audio” signals which when passed to the piezo amplifier 507 generates suitable haptic feedback using the tactile audio display.

In some embodiments the tactile effect generator can output the generated effect to the piezo amplifier 507.

In some embodiments the apparatus comprises a piezo amplifier 507. The piezo amplifier 507 can be a single channel or multiple channel amplifier configured to receive at least one signal channel output from the tactile effect generator 503 and configured to generate a suitable signal to output to at least one piezo actuator. In the example shown in FIG. 6 the piezo amplifier 507 is configured to output a first actuator signal to a first piezo actuator, piezo actuator 1 509 and a second actuator signal to a second piezo actuator, piezo actuator 2 511.

It would be understood that the piezo amplifier 507 can be configured to output more than or fewer than two actuator signals.

In some embodiments the apparatus comprises a first piezo actuator, piezo actuator 1 509 configured to receive a first signal from the piezo amplifier 507 and a second piezo actuator, piezo actuator 2 511, configured to receive a second signal from the piezo amplifier 507. The piezo actuators are configured to generate a motion to produce the tactile feedback on the tactile audio display. It would be understood that there can be more than or fewer than two piezo actuators and furthermore in some embodiments the actuator can be an actuator other than a piezo actuator.

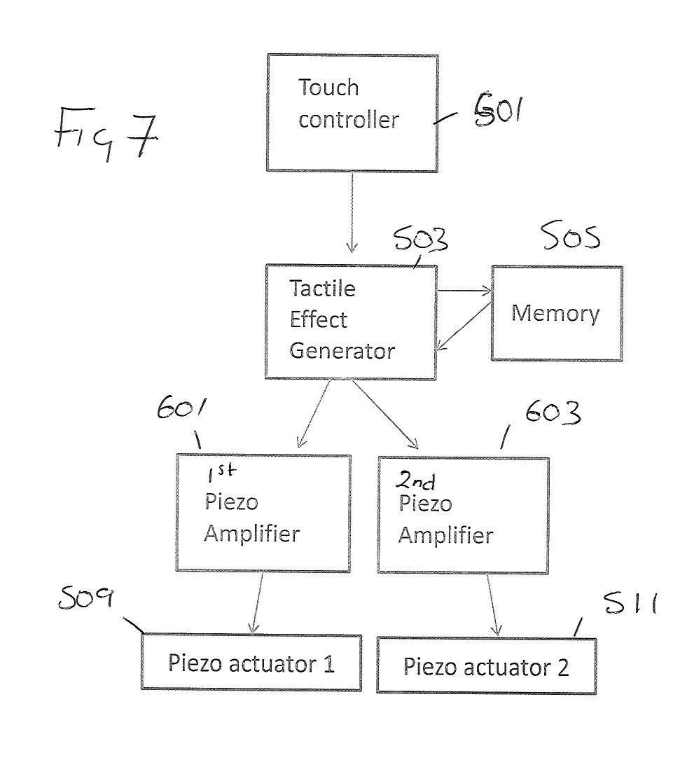

With respect to FIG. 7 the tactile effect generator system apparatus shown differs from the tactile effect generator system apparatus shown in FIG. 6 in that each piezo actuator is configured to be supplied a signal from an associated piezo amplifier. Thus for example as shown in FIG. 7 the first piezo actuator, piezo actuator 1 509 receives an actuation signal from a first piezo amplifier 601 and the second piezo actuator, piezo actuator 2 511 is configured to receive a second actuation signal from a second piezo amplifier 603.

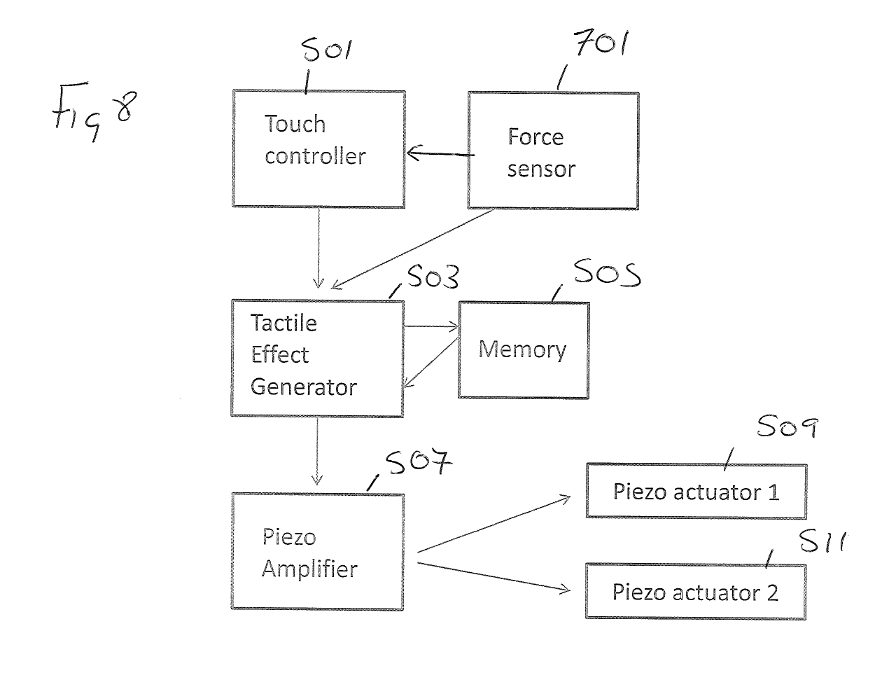

With respect to FIG. 8 the tactile effect generator system apparatus shown differs from the tactile effect generator system apparatus as shown in FIG. 6 in that the tactile effect generator apparatus is configured to receive a further input from a force sensor 701.

In some embodiments therefore the tactile effect generator system apparatus comprises a force sensor 701 configured to determine the force applied to the display. The force sensor 701 can in some embodiments be implemented as a strain gauge or piezo force sensor. In further embodiments the force sensor 701 is implemented as at least one of the piezo actuators operating in reverse wherein a displacement of the display by the force generates an electrical signal within the actuator which can be passed to the touch controller 501. In some other embodiments the actuator output can be passed to the tactile effect generator 503. In some embodiments the force sensor 701 can be implemented as any suitable force sensor or pressure sensor implementation.

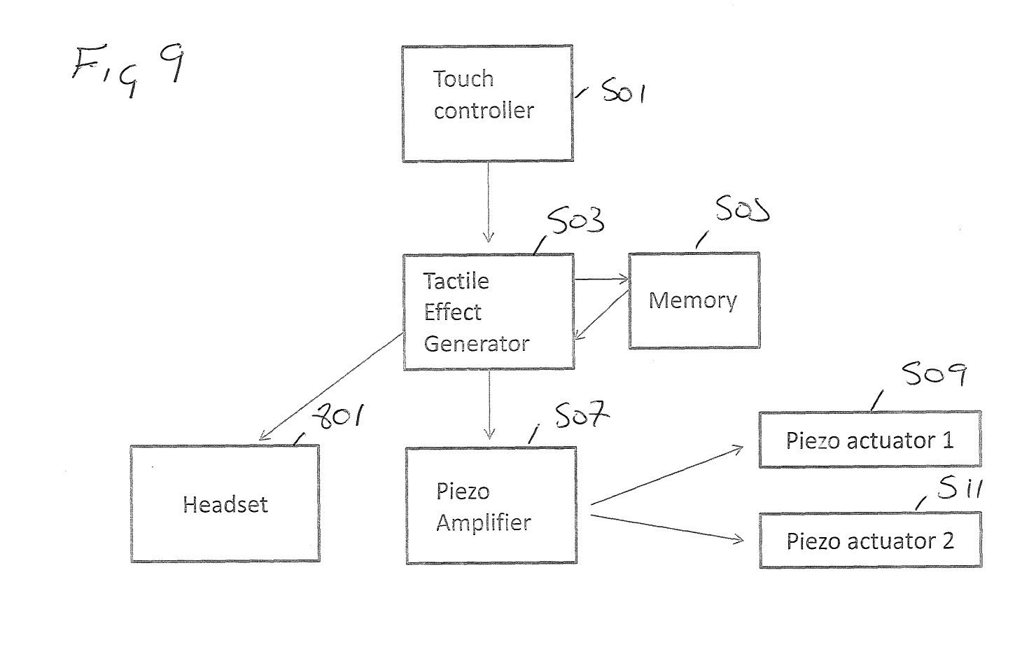

The tactile effect generator system apparatus as shown in FIG. 9 differs from the tactile effect generator system apparatus shown in FIG. 6 in that the tactile effect generator 503 in the example shown in FIG. 9 is further configured to generate not only tactile “audio” signals which are passed to the piezo actuator but configured to generate an audio signal which can be output to an external audio actuator such as the headset 801 shown in FIG. 9. Thus in some embodiments the tactile effect generator 503 can be configured to generate an external audio feedback signal concurrently with the generation of the tactile feedback or separate from the tactile feedback.

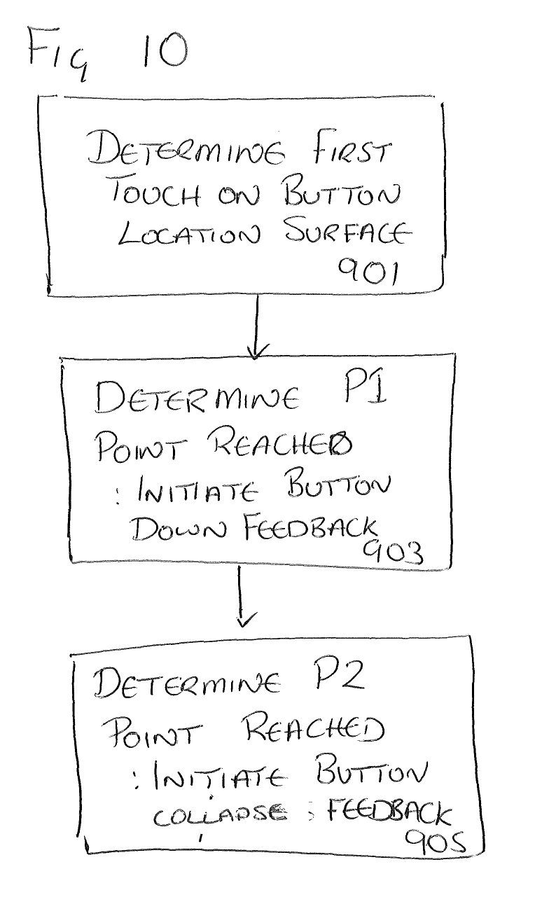

With respect to FIG. 10 the overview of the operation of the touch controller 501 and tactile effect generator 503 with respect to the tactile effect simulation of a mechanical button press is shown in further detail.

In some embodiments the touch controller 501 can be configured to determine when a first touch has been made on the display. The touch controller 501 can further be configured to determine a first touch on the button location surface. In other words that the touch controller 501 has output a touch parameter that a touch contact has been made and at a specific location representing a specific button position.

The determination of a first touch on the button location surface is shown in FIG. 10 by step 901.

The touch controller 501 can then be configured to determine when the P1 point has been reached. On determination of the P1 point being reached the touch controller 501 can be configured to indicate to the tactile effect generator that the P1 point (or operation point) has been reached. The P1 point or operation point indicator can in some embodiments cause the tactile effect generator 503 to then communicate with the memory 505 and initiate the generation of a button operation point feedback tactile effect.

The tactile effect generator 503 can then output the tactile effect to a location approximately near to the button locations. Thus in some embodiments the tactile effect generator 503 can be configured to control the piezo amplifier 507 to output the tactile effect actuation signal to the piezo actuators, 509 and 511 to simulate the button operation at the button position.

The determination of the P1 point and the initiation of the button down feedback is shown in FIG. 10 by step 903.

Furthermore the touch controller 501 can be configured to further determine when the P2 point has been reached, in other words the simulation of the mechanical button complete dome collapse (or when the dome reaches the bottom of the collapse and becomes flat). On determination of the P2 point being reached the touch controller 501 can be configured to indicate to the tactile effect generator that the P2 point (or dome collapse point) has been reached.

The tactile effect generator can then be configured to on receiving the indicator determining the P2 point initiate the dome collapse feedback. In such embodiments the tactile effect generator can be configured to communicate with the memory 505 to determine the “button collapse” or “button grounding” signal where the button reaches the end of the range of movement and pass this signal to the piezo amplifier 507 to be configured to actuate the piezo actuators 509 and 511 to generate the “button collapse” feedback.

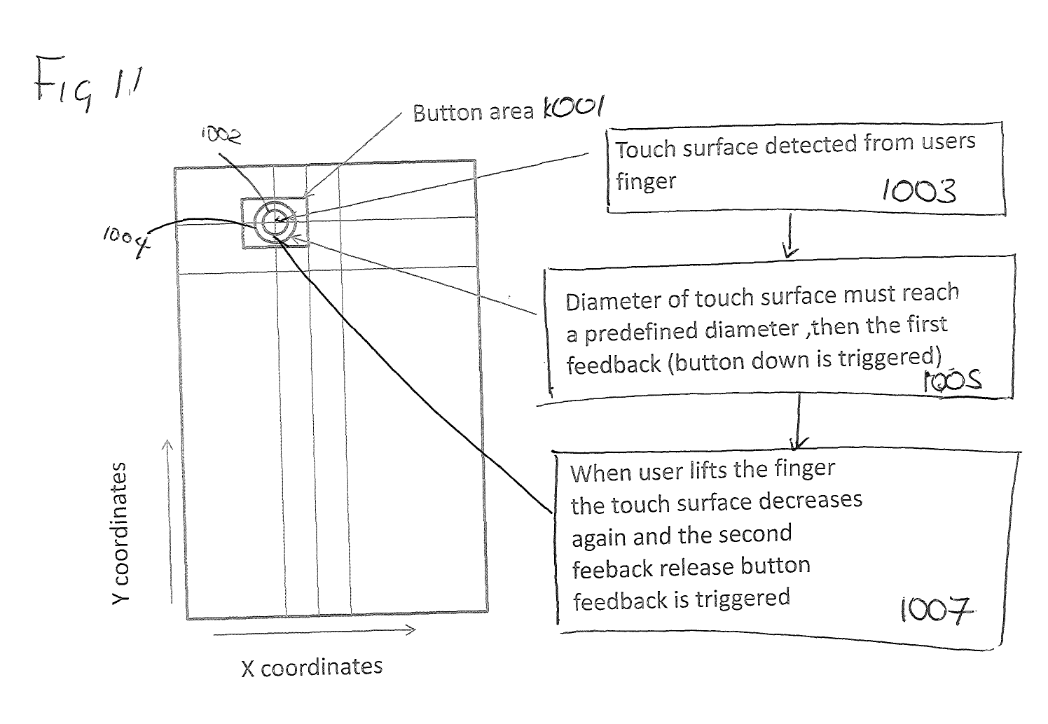

With respect to FIG. 11 an example button location and mechanical button simulation operation where the tactile effect generator system apparatus is configured to determine the P1 and P2 points by the determination of the touch surface area is shown in further detail.

As shown in FIG. 11 the button area 1001 defines a region within which the user can touch the display. Furthermore it would be understood that the greater the pressure the user applies the greater the area of touch surface occurs and can be detected due to deformation of the fingertip under pressure. Thus in some embodiments the touch controller 501 can be configured to detect a first touch surface defined by a first touch surface area 1002.

The operation of detecting the initial surface touch from the user's finger within the button area is shown in FIG. 11 by step 1003.

The touch controller 501 can be configured to indicate to the tactile effect generator that the P1 point (or operation point) has been reached when the diameter of the touch surface reaches a defined diameter. The defined diameter would be indicative that a suitable P1 pressure or force had been exerted on the display. The touch controller 501 can be configured to output to the tactile effect generator 503 that the P1 point has been reached which then can be configured to trigger the button down or operational feedback.

The example of the P1 defined diameter is shown in FIG. 11 by the area marked 1004 which defines a diameter greater than the initial touch position or point surface area.

The determination of the diameter of touch surface reaching a P1 defined diameter and triggering the first feedback or button down feedback is shown in FIG. 11 by step 1005.

In some embodiments the touch controller 501 can be configured to determine further defined diameters. For example in some embodiments the touch controller 501 can be configured to determine the P2 point at a defined diameter greater than the P1 defined diameter area and pass an indicator to the tactile effect generator 503, which in turn causes the tactile effect generator 503 to generate a suitable button collapse or button stop feedback.

In some embodiments the touch controller 501 can be configured to define multiple operational point diameters (or effective pressure or force values) which can define more than one operation for each simulated button. In such embodiments the touch controller 501 can be configured to output a suitable indicator associated with the multiple operational point to the tactile effect generator 503 which in turn can generate a suitable feedback associated with specific determined one of the multiple operation points. For example the button can be a simulated camera shutter button with a first button operational position associated with a focus lock function and a second button operational position associated with the ‘camera shutter’ open setting.

In some embodiments the touch controller 501 can be configured to monitor not only the pressure or force exerted on the display but also the time period associated with the pressure. In some embodiments the touch controller 501 can be configured to generate at least one indicator to the tactile effect generator 503 to generate a suitable tactile feedback dependent on the period of the application of the force.

For example in some embodiments the touch controller 501 can be configured to determine that the pressure on the display is being maintained and provide an indicator to the tactile effect generator 503 to generate a suitable ‘button operational maintained’ tactile feedback. In some embodiments the tactile effect generator 503 can be configured to change or modify the suitable tactile feedback dependent on the period the simulated button is held in at least one of the operational or operation release positions. For example in some embodiments the tactile effect generator can be configured to increase the amplitude of the suitable tactile feedback the longer the simulated button is held. In some embodiments this ‘hold’ or ‘held’ feedback can be implemented when the point of contact moves while the ‘button’ is held down and emulate contextual feedback as described herein.

In some embodiments as described herein the touch controller 501 can be configured to determine motion of the point of contact and provide an indicator to the tactile effect generator 503 to generate a suitable motion, direction or position based tactile effect. For example in some embodiments the touch controller 501 can be configured to detect the motion of the point of contact and cause the tactile effect generator 503 to generate a button contact slip when the point of contact is far enough from the button location to simulate when a user's finger slips off the button.

Then once the user lifts their finger the touch surface will decrease. The tactile effect generator 503 can be configured to determine when the touch surface diameter is less than a further defined diameter, smaller than the first defined diameter and generate the second or release button feedback.

The second touch surface diameter is shown in FIG. 11 by the diameter 1002.

The operation of triggering the second feedback or release button feedback when the user lifts their finger and the touch surface decreases is shown in FIG. 11 by step 1007.

In the camera example described herein the release of the button could in some embodiments be the simulated ‘shutter release’ operation where the ‘shutter release’ is manually controlled.

It would be understood that in some embodiments there can be more than one simulated button release operational point, and that in some embodiments each of the simulated button release operations points can be associated with a tactile feedback. In some embodiments the tactile feedback signals differ for at least two of the simulated button release operation points.

In some embodiments where the touch controller 501 receives an input from a force or pressure sensor such as shown in FIG. 8 by the force sensor 701, the touch controller 501 can be configured to use the sensor input to determine the operational, dome collapse, operational release, motion and period dependent states and generate suitable indication to the tactile effect generator 503. The tactile effect generator 503 can then be configured to generate a simulated mechanical button press simulated tactile effect dependent on the force/pressure input.

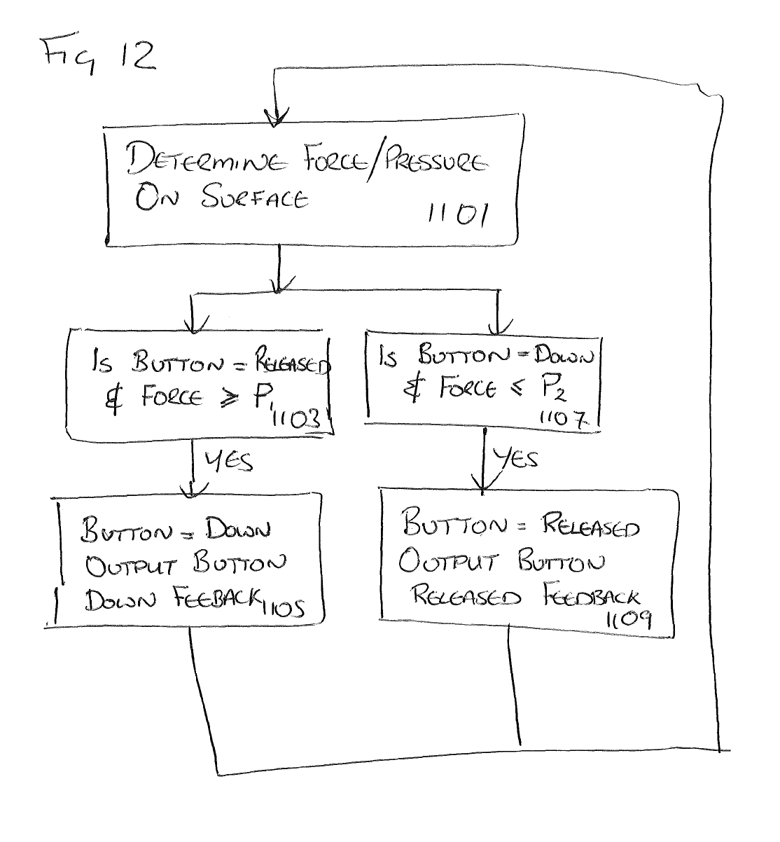

With respect to FIG. 12 the operation of the tactile effect generator 503 in simulating a mechanical button press when receiving a force or pressure input is shown in further detail.

In some embodiments the touch controller 501 on determining a button press at a location can be further configured to determine the force or pressure on the surface using the force sensor input.

The determination of the force or pressure on the surface is shown in FIG. 12 by step 1101.

The touch controller 501 can then be configured to check whether or not the button associated with the touch location is currently in a released or down position. Where the button is in a released (or off) state then the touch controller 501 checks whether the force is greater than a first defined force or pressure value P1.

The operation of determining when the button is in a released state and the force is greater than P1 is shown in FIG. 12 by step 1103.

Where the button is in a released state and the force is greater than P1 then the tactile effect generator 503 can be configured to change the state of the button to being “down” or “on” and further generate or output the button down or operation point feedback.

The button down or operation feedback generation and the setting of the state of the button to down or “on” is shown in FIG. 12 by step 1105.

The operation can then pass back to the determination of the force or pressure on the surface in other words pass back to step 1101.

The operation of determining that the button is currently in a down state and the force is less than P2 is shown in FIG. 12 by step 1107.

Where the touch controller 501 determines that the button state is down and the pressure is less than P2 then the tactile effect generator 503 can be configured to change the state of the button to being released and output the button released feedback generated signal.

The operation then of changing the button state to released and outputting the button released feedback is shown step 1109 of FIG. 12.

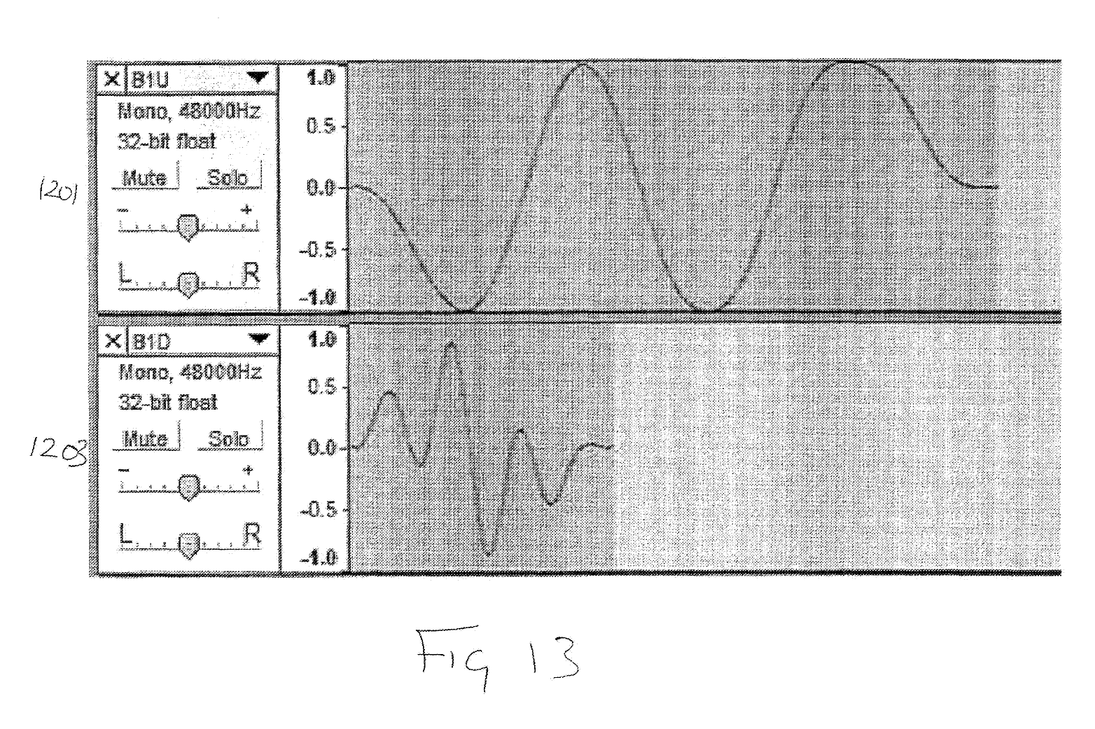

With respect to FIG. 13 wave forms of example tactile feedback signals are shown.

A first tactile feedback signal 1201 shows a piezo drive signal where the amplitude is high and the duration is longer making the feedback feel strong. In order to also sense the signal strongly the feedback frequency can be set to be between 200-300 Hz.

Furthermore with respect to FIG. 13 a second tactile feedback signal 1203 represents a piezo drive signal where the average amplitude is low and the duration is shorter making the feedback feel weaker. Furthermore in this example the frequency is higher than in the example discussed above so that the tactile signal does not feel as strong.

It would be understood that as well as simulating a mechanical button press the tactile effect generator system apparatus as shown in FIGS. 6 to 9 can be used to implement tactile simulation of mechanical functions for any suitable user interface input.

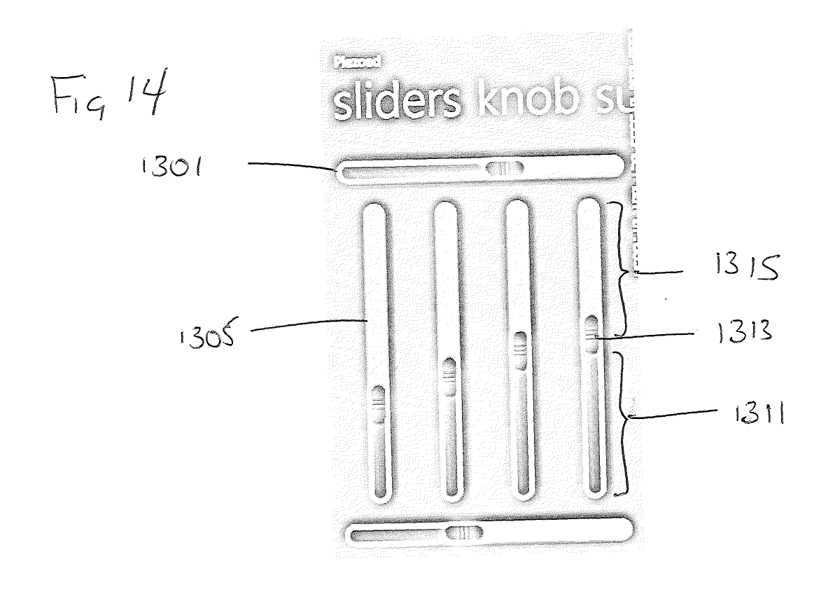

With respect to FIGS. 14 to 16 the tactile effect generator is shown performing a simulation of a mechanical slider by generating suitable tactile effects.

With respect to FIG. 14 example display sliders are shown in a manner which they could be implemented on a tactile audio display. The sliders shown in FIG. 14 are horizontal sliders 1301, and vertical sliders 1305 however it would be understood that any suitable slider can be generated. The slider typically defines a “thumb” point 1313 within the slider track which defines a first part of the slider track 1311 to one side of the thumb 1313 and a second portion of the track 1315 the other side of the thumb 1313, the position of the thumb defining an input for the apparatus.

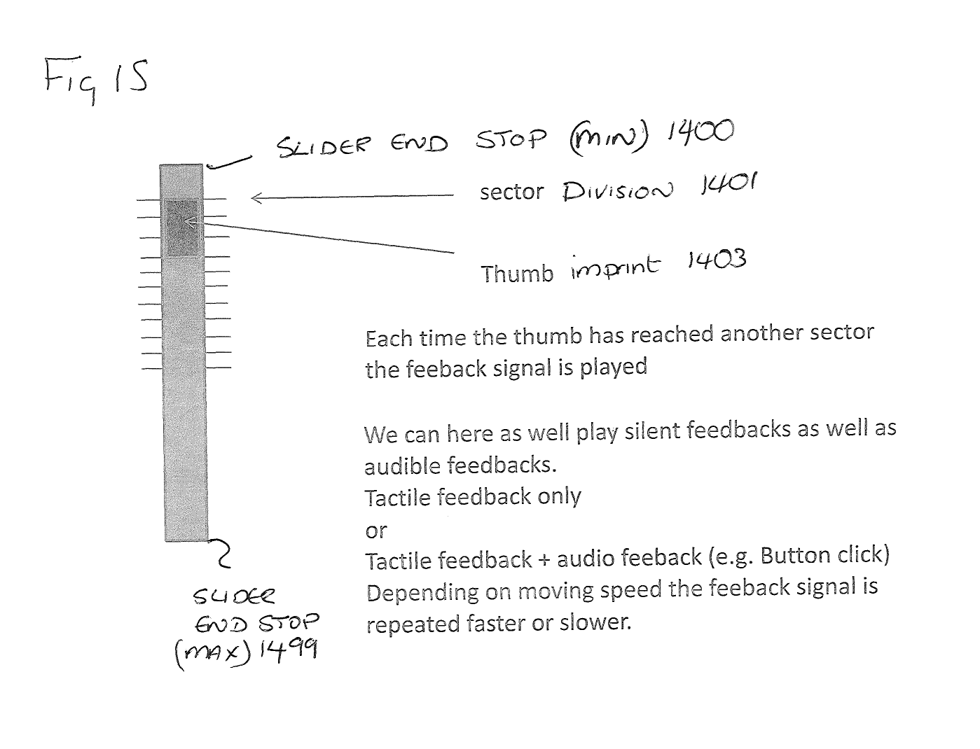

The features of a slider are further shown in FIG. 15. A slider typically has a first (or minimum) end stop 1400 at one end of the slider track, a second (or maximum) end stop 1499 at the opposite end of the slider track and a thumb 1403 within the track defining the first and second portions and therefore defining the value relative to the minimum and maximum end stop points. In some embodiments the slider track is divided into sectors. The sectors are bounded by sector divisions 1401. The sector divisions can be linear or non-linear in spacing. In a mechanical slider the thumb is physically stopped when reaching the end stops and furthermore in some embodiments produces a mechanical click as it passes each sector division.

Although the sliders shown in FIGS. 14 and 15 are linear sliders (in other words a straight line) it would be understood that in some embodiments the slider path or track can be curved or otherwise non-linear in implementation. Furthermore in some embodiments the slider can be allowed to move along more than one path or track, for example a track can bifurcate and the thumb be allowed to be moved along at least one of the bifurcated paths at the same time.

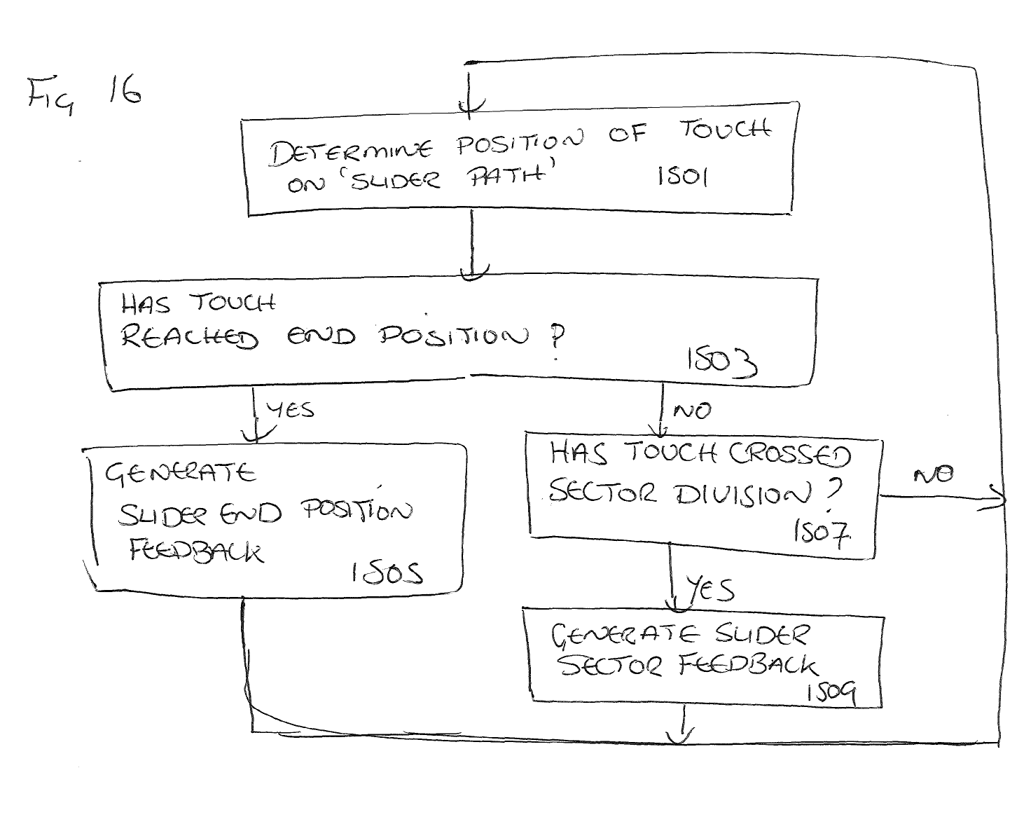

With respect to FIG. 16 the operation of the touch controller 501 and tactile effect generator 503 in generating a tactile effect simulating the mechanical slider is described in further detail.

The touch controller 501 can be configured to determine a position of touch on the slider path representing the thumb position.

The operation of determining the position of touch on the slider path is shown in FIG. 16 by step 1501.

The touch controller 501 can be configured to determine whether or not the touch or thumb position has reached one of the end positions.

The operation of determining whether not the touch or thumb has reached the end position is shown in FIG. 16 by step 1503.

Where the touch has reached the end position then the touch controller 501 can be configured to pass an indicator to the tactile effect generator 503 so that the tactile effect generator can be configured to generate a slider end position tactile feedback. The slider end position feedback can produce a haptic effect into the fingertip, which in some embodiments is also audible as the display vibrates allowing the user to know that the limit of the slider has been reached. In some embodiments the slider feedback is dependent on which end position has been reached, in other words the slider feedback signal for one end position can differ from the slider feedback signal for another end position.

The generation of the slider end position feedback is show in FIG. 16 by step 1505.

Where the touch or thumb has not reached the end position then the touch controller 501 can be configured to determine whether or not the touch or thumb has crossed a sector division.

The operation of determining whether the touch has crossed a sector division is show in FIG. 16 by step 1507.

Where the touch has not crossed a sector division then the operation passes back to determining the position of touch on the slider path, in other words reverting back to the first step 1501.

Where the touch has crossed the sector division then the touch controller 501 can be configured to pass an indicator to the tactile effect generator 503 to cause the tactile effect generator 503 to be configured to generate a slider sector transition feedback signal. The sector transition feedback signal can in some embodiments be different from the slider end position feedback signal. For example in some embodiments the sector transition feedback signal can be a shorter or sharper click tactile signal than the slider end position feedback.

The operation of generating a slider sector feedback is shown in FIG. 16 by step 1509. After generating the slider sector feedback the operation can then pass back to the first step of determining a further position of the touch or thumb on the slider path.

In some embodiments the slider can be a button slider in other words the slider is fixed in position until a sufficient pressure unlocks it from that position. In such embodiments the combination of the slider and mechanical button press tactile effect can be generated for simulating the effect of locking and unlocking the slider prior to and after moving the slider. For example in some embodiments the touch controller 501 can determine the pressure or force at which the slider thumb position is being pressed and permit the movement of the slider thumb only when a determined pressure is met or passed. In some embodiments the determined pressure can be fixed or variable. For example movement between thumb positions between lower values can require a first pressure or force and movement between thumb positions between higher values can require a second pressure or force greater than the first to simulate an increased resistance as the slider thumb value is increased.

Although the slider divisions shown FIGS. 14 and 15 show even size divisions it would be understood that in some embodiments the sized divisions can differ, for example a logarithmic or exponential division ratio can be implemented in some embodiments. Furthermore in some embodiments it would be understood that the simulated sliders can be configured with a sector size, the distance between sector divisions, which can be any suitable distance. In such embodiments as the sector distance tends to a zero distance then the simulated slider simulates a stepless or analogue slider. In some embodiments, where the sector distance is small then then the tactile effect generator is configured to output tactile effect values after a determined number of sector divisions are crossed. This sector crossing determined number can be constant or dependent on the current position of the thumb (to generate in such embodiments a non-linear output).

Furthermore in some embodiments the direction in which the slider is moved can be determined by the touch controller 501, which then can be configured to pass an indicator to the tactile effect generator 503 which then is configured to generate a tactile effect dependent on the direction of motion of the thumb on the slider track. Thus for example in some embodiments the tactile feedback can be greater as the thumb moves ‘up’ the track and the output value is increased when compared to the tactile feedback as the thumb moves ‘down’ the track and the output value is decreased.

In some embodiments the relative position of the slider thumb on the track can be determined by the touch controller 501, which then can be configured to pass an indicator to the tactile effect generator 503 which then is configured to generate a tactile effect dependent on the position of the thumb on the slider track. Thus in some embodiments it can be possible to mimic a slider where the slider ‘resistance’ increases, in other words the feedback gets stronger, the higher the slider thumb is. In some embodiments the determined position at which the touch controller outputs an indicator can be fixed or variable. For example the slider can in some embodiments be a thermostat setting for a heating system for a building. In such embodiments one of the determined positions could represent a fixed temperature, for example 25 degrees Celsius so to prevent energy wastage, to indicate that the user is passing a determined setting or safety limit. In some embodiments one of the determined positions could represent the current temperature experienced by the building and therefore be variable dependent on the surrounding temperature.

In some embodiments the slider thumb can be configured to have inertia, in other words once moving the removal of the point of contact from the slider thumb does not cause an instant stop to the slider thumb motion. In such embodiments the touch controller 501 is configured to determine when contact is removed and indicate to the tactile effect generator 503 that a tactile effect is not to be generated. In some embodiments the touch controller 501 can be configured when determining that contact has been removed to generate an indicator for the audio controller or vibra controller to generate audio or vibra feedback which is more likely to be experienced.

In some embodiments the slider is implemented as a virtual slider, in that the slider thumb position is static and the track moves about the static position. In some embodiments the virtual slider has no slider end positions and in some embodiments can loop about the end values, in other words moving the slider value past the maximum value produces a minimum value and vice versa.

In some embodiments the slider may have at least one active axis and an inactive axis. The active axis for example would as described herein be the one which permits the slider thumb to move along. In some embodiments the inactive axis is the axis which does not permit movement of the thumb. For example with a slider where the thumb can move ‘up’ and ‘down’ the slider inactive axis can be the ‘side’ to ‘side’ one. In such embodiments any attempted motion on the inactive axis can be detected by the touch controller 501, which then can be configured to pass an indicator to the tactile effect generator 503 which then is configured to generate a tactile effect. In such embodiments the tactile effect generator 503 can be configured to generate a tactile effect similar to the end position effect.

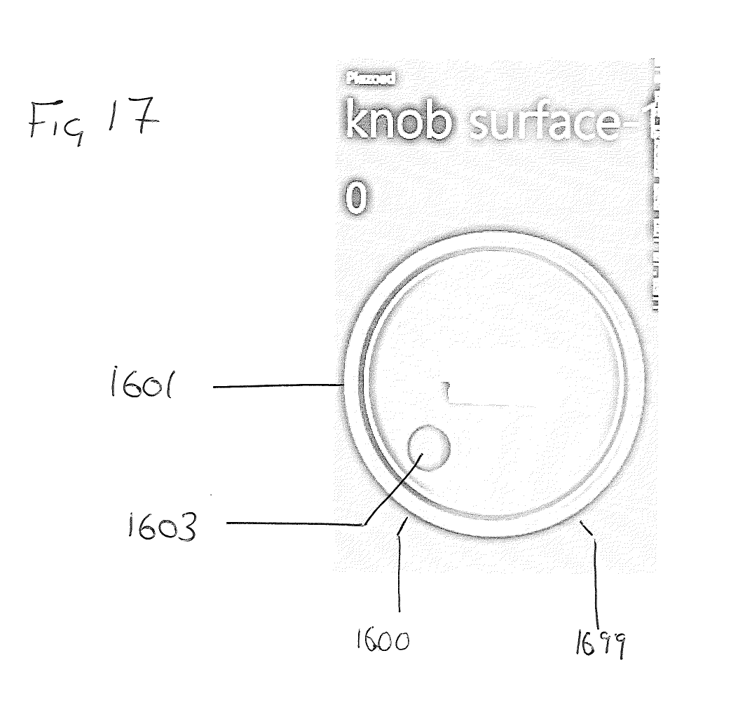

With respect to FIGS. 17, 18 and 19 the touch controller 501 and tactile effect generator 503 operating as a knob or dial tactile effect generator is shown in further detail.

With respect to FIG. 17 an example display image of a knob or dial is shown. The knob or dial 1601 is configured with an index arrow 1603 indicating the current position of the knob or dial. Furthermore in some embodiments the knob or dial can have a defined end stop minimum position 1600 and an end stop maximum position 1699. In some embodiments the knob or dial can be a multiple rotation knob or dial, in other words the knob or dial can rotate a number of times between the minimum and maximum points or in some embodiments can continuously rotate without having minimum and maximum endpoint positions.

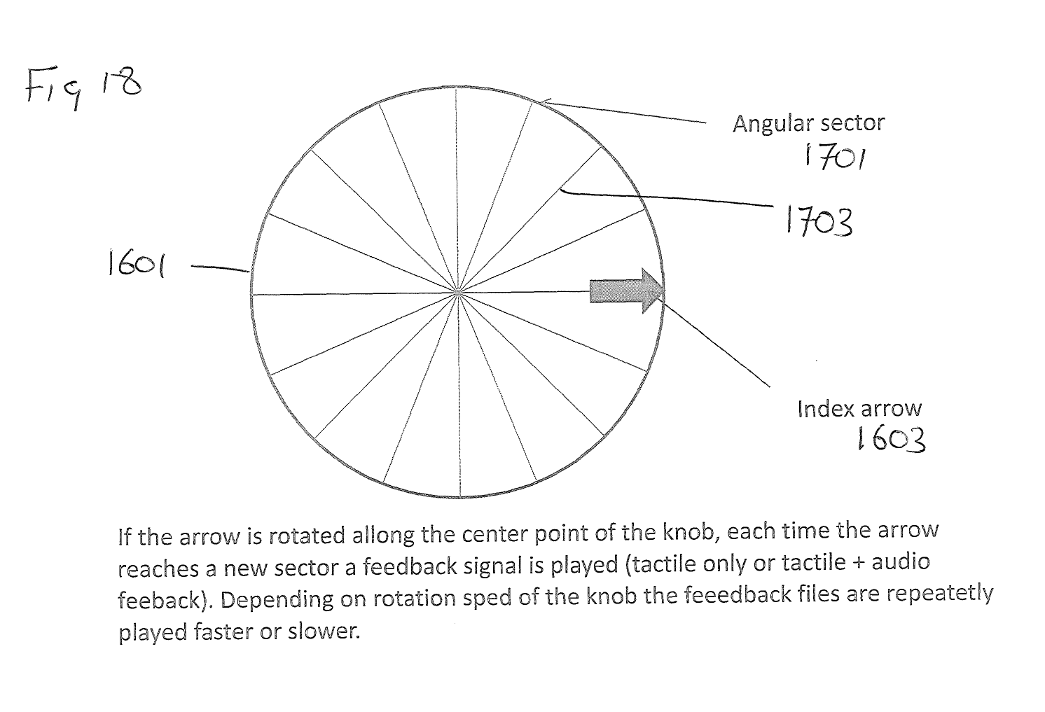

With respect to FIG. 18 the dial or knob is shown wherein the dial or knob 1601 with index arrow 1603 is configured to rotate along a centre point of the dial or knob and the dial or knob motion is defined with respect to the angular sectors 1701 which are bounded by angular sector divisions 1703. The example shown in FIG. 18 demonstrates a constant or regular angular sector configuration, however it would be understood that in some embodiments the angular sectors can be non-linearly spaced for example the angular sectors could be logarithmically or exponentially defined.

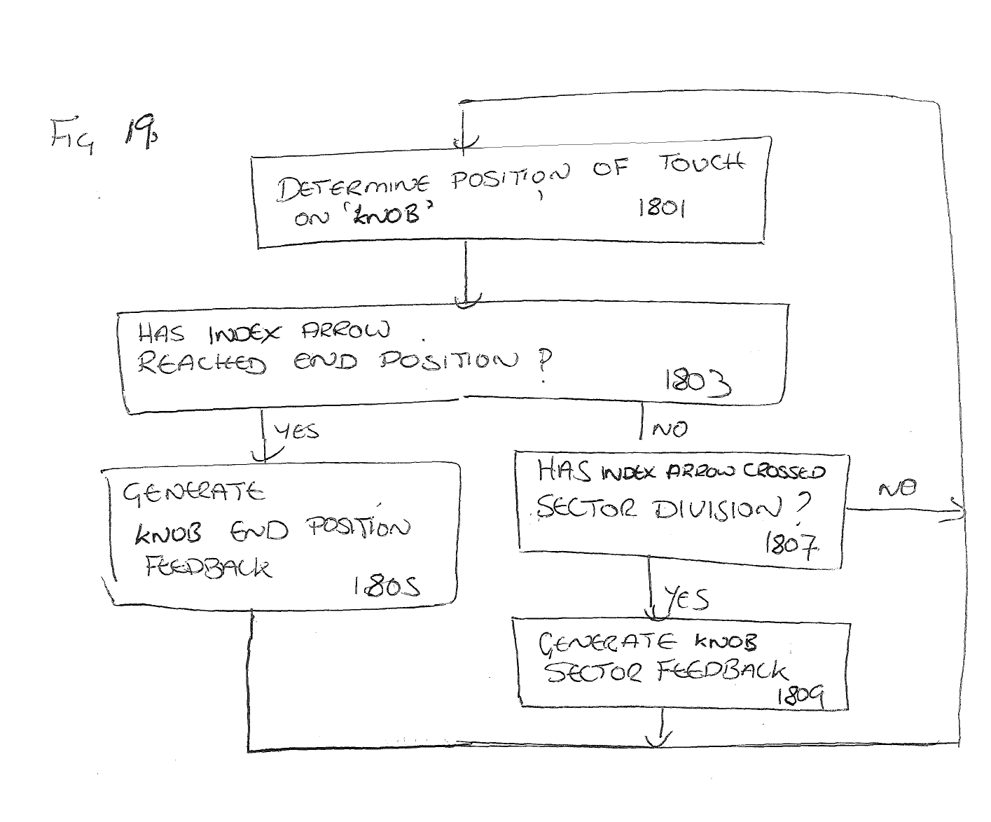

With respect to FIG. 19 an example operation of the touch controller 501 and tactile effect generator 503 performing the operating of simulating a knob or dial tactile effect is described in further detail.

The touch controller 501 can be configured to receive the touch parameters from the display and determine the position, pressure, force, motion or any other suitable touch parameter with respect to the touch on the knob or dial.

The operation of determining the position of touch on the knob is show in FIG. 19 by step 1801.

The touch controller 501 can furthermore monitor the position of the touch and determine whether the index arrow (in other words knob or dial) has reached one of the end positions.

The determination of whether the index arrow/dial or knob has reached on of the end stop positions is shown in FIG. 19 by step 1803.

Where the knob or dial has reached the end position then the tactile effect generator 503 can be configured to generate a knob end position feedback signal. In some embodiments the knob end feedback is dependent on which end position has been reached, in other words the dial or knob feedback signal for one end position can differ from the dial or knob feedback signal for another end position.

The generation of the knob end position feedback signal is shown by 1805 of FIG. 19.

Furthermore following the generation of the knob end position feedback the touch controller 501 can monitor the position of the touch or knob for a further position, in other words revert back to step 1801 of FIG. 19.

Where the touch controller 501 determines that the index arrow or dial has not reached an end stop position then the touch controller 501 can determine whether or not the index arrow has crossed the sector division.

The operation of detecting whether the index arrow has crossed a sector division is shown in FIG. 19 by step 1807.

Where no sector division has been crossed then the operation has passes back to step 1801, in other words the touch controller 501 monitors the position of the knob or dial to determine further motion of the knob or dial.

Where the touch controller 501 determines that there has been a sector division crossing then the touch controller 501 can send an indicator to the tactile effect generator 503 which can be configured to generate a knob sector transition feedback signal. The knob sector transition feedback signal can in some embodiments be different from the knob end position feedback signal. For example the sector transition feedback signal can be in some embodiments a sharper shorter signal than the end point feedback signal.

The knob sector transition feedback signal generation operation is shown in FIG. 19 by step 1809.

Following the generation of a knob sector transition feedback signal then the tactile effect generator can be configured to determine the position of the touch on the knob to determine any further motion, in other words pass back to step 1801 of FIG. 19.

It would be understood that in some embodiments the knob position can be locked requiring a sufficient pressure to unlock it. In such embodiments the mechanical button tactile effects and dial or knob effects can be combined such that a tactile effect simulating a mechanical button is required before enabling the motion and after the monitor of the dial. For example in some embodiments the touch controller 501 can determine the pressure or force at which the knob position is being pressed and permit the movement of the arrow only when a determined pressure is met or passed. In some embodiments the determined pressure can be fixed or variable. For example movement between arrow positions between lower values can require a first pressure or force and movement between arrow positions between higher values can require a second pressure or force greater than the first to simulate an increased resistance as the dial arrow value is increased.

Furthermore in some embodiments it would be understood that the simulated knob can be configured with a sector size, the distance between sector divisions, which can be any suitable distance. In such embodiments as the sector distance tends to a zero angle then the simulated knob simulates a stepless or analogue knob or dial. In some embodiments, where the sector distance is small then then the tactile effect generator is configured to output tactile effect values after a determined number of sector divisions are crossed. This sector crossing determined number can be constant or dependent on the current position of the arrow (to generate in such embodiments a non-linear output).

Furthermore in some embodiments the direction in which the knob or dial is moved can be determined by the touch controller 501, which then can be configured to pass an indicator to the tactile effect generator 503 which then is configured to generate a tactile effect dependent on the direction of motion of the arrow. Thus for example in some embodiments the tactile feedback can be greater as the arrow moves ‘clockwise’ and the output value is increased when compared to the tactile feedback as the arrow moves ‘anti-clockwise’ and the output value is decreased.

In some embodiments the position of the knob or dial arrow can be determined by the touch controller 501, which then can be configured to pass an indicator to the tactile effect generator 503 which then is configured to generate a tactile effect dependent on the position of the knob or dial. Thus in some embodiments it can be possible to mimic a dial where the ‘resistance’ increases, in other words the feedback gets stronger, the further clockwise the arrow is.

In some embodiments the touch controller can be configured to output an indicator when a determined position is reached which is configured to permit the tactile effect generator to output a feedback signal different from a sector transition feedback signal. In some embodiments the determined position can be fixed or variable.

For example the dial or knob can in some embodiments be an on/off and volume control dial. In such embodiments one of the determined positions could represent the initial on/off position where a position clockwise of this position indicates the associated component is on and a position anticlockwise of this position indicated the associated component is off. The touch controller can be configured to generate a suitable on/off click tactile feedback signal on transition of this position.

In some embodiments the dial or knob can be configured to have inertia, in other words once moving the removal of the point of contact from the dial or knob does not cause an instant stop to the arrow motion. In such embodiments the touch controller 501 can be configured to determine when contact is removed and indicate to the tactile effect generator 503 that a tactile effect is not to be generated. In some embodiments the touch controller 501 can be configured when determining that contact has been removed to generate an indicator for the audio controller or vibra controller to generate audio or vibra feedback which is more likely to be experienced.

In some embodiments the simulated mechanical button feedback effect uses only the button down feedback in other words bypassing or not generating the button up or button release feedback.

In some embodiments the tactile effect generator 503 can be configured to generate a continuous feedback signal whilst the button is determined by the touch controller 501 to be held down, in other words there can be a continuous feedback signal generated whilst the button is active or operational.

In some embodiments it would be understood that the button down and release pressure points can differ from button to button. For example in some embodiments there can be a correlation between the size of the displayed button and the pressure required in order to generate the feedback such that the user experiences that the characteristics of the buttons differ.

In some embodiments a sequence or series of presses can produce different feedback signals. In other words the tactile effect generator 503 can be configured to generate separate feedback signals when determining that the button press is a double click rather than two separate clicks.

Although the implementations as described herein refer to simulated experiences of button clicks, sliders and knobs and dials it would be understood that the tactile effect generator 503 can be configured to produce tactile effects for simulated experiences based on the context or mode of operation of the apparatus.

Thus for example the tactile effect generator 503 can be configured to supply simulated mechanical button tactile effects during a drag and drop operation. A drag and drop operation could be implemented as pressing in a button, and therefore selecting the object under the point of contact at one position maintaining contact while moving the object (dragging the selected object) and releasing the button (and dropping the object) at a second position. The tactile effect generator 503 can thus be configured to generate a drag and drop specific feedback to enable a first feedback or selection, another on dragging and further and dropping.

In some embodiments the tactile effect context can be related to the position on the display. Thus for example dropping at one position could generate a first feedback and dropping at a second position generate a second feedback.

In some embodiments a context can be related to the speed or direction of the dragging or movement. In some embodiments the context can depend on any display elements underneath the current touch position. For example when moving an object across a screen any crossing of window boundaries could be detected and the tactile effect generator 503 generate a tactile feedback on crossing each boundary. Furthermore in some embodiments the boundary can be representative of other display items such as buttons or icons underneath the current press position.

In some embodiments the tactile effect generator 503 can be configured to generate tactile effect haptic feedback for scrolling. The scrolling operation can be consider to be similar to a slider operation in two dimensions. For example where a document or browser page or menu does not fit a display then the scrolling effect has a specific feedback when reaching the end of the item and in some embodiments moving from page to page or paragraphs to paragraphs (simulating sectors on a slider). The feedback can in some embodiments depend on the scrolling speed, the direction of the scrolling, and what is occurring underneath the scrolling position. For example in some embodiments the touch controller 501 and the tactile effect generator 503 can be configured to generate tactile control signals based on any display objects which disappear or reach the edge of the display as the touch controller 501 determines the scrolling motion.

Although in the embodiments shown and described herein are single touch operations such as button, slider and dial it would be understood that the tactile effect generator 503 can be configured to generate tactile effects based on multi-touch inputs.

For example the tactile effect generator could be configured to determine feedback for a zooming operation where two or more fingers and the distance between the fingers define a zooming characteristic (and can have a first end point and second end point and sector divisions). Similarly multi-touch rotation where the rotation of the hand or fingers on the display can have a first end point, a second end point, and rotation divisions and be processed emulating or simulating the rotation of a knob or dial structure.

In some embodiments drop down menus and radio buttons can be implemented such that they have their own feedback in addition to buttons. In other words in general all types of press and release user interface items can have their own feedback associated with them. Furthermore in some embodiments hold and move user interface items can have their own feedback associated with them.

In some embodiments a browser link or hyperlink can be detected by the tactile effect generator and implemented as a simulated mechanical button with a link feedback signal.

Furthermore in some embodiments swiping or specific gestures which can be detected or determined can have their own feedback. In some embodiments this feedback can depend not only on the gestures but the speed of the gestures.

In some embodiments the tactile feedback generated can be a simulated stay down or ‘latched’ button. A stay down button is one which operates in two states but when pressed down to the operational state stays down in the operations state. When the stay down button is pressed again, the button pops back to the off state or in other words is released. In such embodiments the touch controller and tactile feedback generator can thus operate with four feedback signals. These four feedback signals can be, a first feedback signal, feedback 1 generated when the dome collapse starts. A second feedback signal, feedback 2, when the dome collapse ends. A third feedback signal, feedback 3, for the dome release start. Finally a fourth feedback signal, feedback 4, generated for dome release end.

In some embodiments the tactile feedback generated can be a simulated trackball. In such embodiments the trackball can be implemented by a continuous or unbounded two-dimensional slider. In some embodiments the trackball simulation can be implemented by the touch controller and tactile feedback generator to generate different tactile feedback to determined motion in a first (x) and second (y) dimension. In some embodiments the the touch controller and tactile feedback generator can simulate the trackball in terms of feedback being a combination (for example a sum) of first and second dimension motion. Furthermore it would be understood that in some embodiments the simulated trackball can implement feedback similar to any of the feedback types described herein with respect to sliders and knobs.

In some embodiments the tactile feedback can be a simulated isometric joystick or pointing stick. In such embodiments the touch controller and tactile feedback generator can thus operate to generate feedback which in some embodiments can be different for a first direction or dimension (x) and a second direction or dimension (y). Furthermore in some embodiments the touch controller and tactile feedback generator can be configured to generate feedback when simulating an isometric joystick depended on the force that applied to the stick, where the force is the force towards the first and second directions. The touch controller and tactile feedback generator in such embodiments could implement such feedback, as on the display there is nothing physical that would resist the force, by generating feedback dependent on the distance the finger is moved from the touch point (over the stick) after it has been pressed. Thus the feedback in such embodiments would get stronger the further away the finger is moved from the original touch point.

In some embodiments the touch controller and tactile feedback generator can when receiving or determining force sensing data generate a tactile feedback signal which is a combination (for example a sum) of force applied towards the display (z axis) and the force (or determined distance from the touch point) in x and y axes.

In some embodiments the touch controller and tactile feedback generator can be configured to generate tactile feedback for the isometric joystick simulating a button press. Furthermore in some embodiments the tactile feedback simulated isometric joystick can implement feedback for a latched or stay down button in a manner described herein.

Furthermore it would be understood that in some embodiments the tactile feedback simulated isometric joystick can implement feedback similar to any of the feedback types described herein with respect to knobs.

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the design of various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The design of embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory used in the design of embodiments of the application may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be designed by various components such as integrated circuit modules.

As used in this application, the term ‘circuitry’ refers to all of the following:
(a) hardware-only circuit implementations (such as implementations in only analogue and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-34. (canceled)

35. A method comprising:
determining at least one touch input parameter for at least one user interface element of a tactile audio display;
determining a touch event dependent on the at least one touch input parameter; and
generating a tactile feedback signal and an audio feedback signal to be output by the tactile audio display dependent on the touch event for the at least one user interface element such that the at least one user interface element provides a simulated experience.

36. The method as claimed in claim 35, wherein determining at least one touch input parameter comprises at least one of:
determining a touch location;
determining a touch position;
determining a touch pressure;
determining a touch force;
determining a touch period;
determining a touch duration; and
determining a touch motion.

37. The method as claimed in claim 36, wherein determining a touch force comprises at least one of:
determining a force sensor output; and
determining a touch contact area size, wherein the touch force is proportional to the touch contact area size.

38. The method as claimed in claim 35, wherein the user interface element of the tactile audio display comprises a switch and determining the touch event comprises at least one of:
determining at least one switch actuation point;
determining a switch end stop point;
determining a switch actuation period; and
determining at least one switch actuation release point.

39. The method as claimed in claim 35, wherein the user interface element comprises a slider and determining the touch event comprises at least one of:
determining at least one slider end stop;
determining at least one slider sector transition position;
determining at least one slider determined position; and
determining at least one slider actuation point.

40. The method as claimed in claim 39, wherein when the at least one slider determined position is determined, the method further comprises at least one of:
a fixed position;
a position dependent on a sensor input; and
a position dependent on a user input.

41. The method as claimed in claim 35, wherein the user interface element comprises a dial and determining the touch event comprises at least one of:
determining at least one dial end stop;
determining at least one dial sector transition position;
determining at least one dial determined position; and
determining at least one dial actuation point.

42. The method as claimed in claim 35, wherein the user interface element comprises a drag and drop input and determining the touch event comprises at least one of:
determining a selection input;
determining a drop input;
determining a boundary transition position; and
determining a collision position.

43. The method as claimed in claim 35, wherein the user interface element comprises a scrolling input and determining the touch event comprises at least one of:
determining a motion input; and
determining a boundary event for a display component.

44. The method as claimed in claim 35, wherein the user interface element comprises a press and release input and determining the touch event comprises at least one of:
determining an activation input; and
determining a release input.

45. The method as claimed in claim 35, wherein the user interface element comprises a latched switch input and determining the touch event comprises at least one of:
determining a first activation input;
determining a latched release input;
determining a latched activation input; and
determining a release input.

46. The method as claimed in claim 35, wherein the user interface element comprises a rollerball and determining the touch event comprises at least one of:
determining a motion input in a first direction;
determining a motion input in a second direction;
determining an activation input; and
determining a release input.

47. The method as claimed in claim 35, wherein the user interface element comprises an isometric joystick and determining the touch event comprises at least one of:
determining a distance input in a first direction;
determining a distance input in a second direction;
determining an activation input; and
determining a release input.

48. The method as claimed in claim 35, wherein generating the tactile feedback signal comprises:
determining a first feedback signal;
modifying the first feedback signal dependent on the determined touch event; and
outputting the modified first feedback signal to at least one actuator to produce the tactile feedback signal.

49. An apparatus comprising at least one processor and at least one memory including computer code for one or more programs, the at least one memory and the computer code configured to with the at least one processor causes the apparatus to:
determine at least one touch input parameter for at least one user interface element of a tactile audio display;
determine a touch event dependent on the determined at least one touch input parameter; and
generate a tactile feedback signal and an audio feedback signal to be output to be output by the tactile audio display dependent on the touch event for the at least one user interface element such that the at least one user interface element provides a simulated experience.

50. The apparatus as claimed in claim 49, wherein the determined at least one touch input parameter causes the apparatus to at least one of:
determine a touch location;
determine a touch position;
determine a touch pressure;
determine a touch force;
determine a touch period;
determine a touch duration; and
determine a touch motion.

51. The apparatus as claimed in claim 50, wherein the determined touch force causes the apparatus to at least one of:
determine a force sensor output; and
determine a touch contact area size, wherein the touch force is proportional to the touch contact area size.

52. An apparatus comprising:
a touch controller configured to determine at least one touch input parameter for at least one user interface element of a tactile audio display;
the touch controller further configured to determine a touch event dependent on the determined at least one touch input parameter; and
a tactile effect generator configured to generate a tactile feedback signal and an audio feedback signal to be output by the tactile audio display dependent on the touch event for the at least one user interface element such that the at least one user interface element provides a simulated experience.

53. The apparatus as claimed in claim 52, wherein the touch controller is configured to determine at least one of:
a touch location;
a touch position;
a touch pressure;
a touch force;
a touch period;
a touch duration; and
a touch motion.

54. The apparatus as claimed in claim 53, wherein the touch controller when the touch force is determined comprises at least one of:
an input configured to receive a force sensor output; and
a contact area determiner configured to determine a touch contact area size, wherein the touch force is proportional to the touch contact area size.
